(19) United States
(12) Patent Application Publication
(10) Pub. No.: US 2007/0192419 A1
(43) Pub. Date: Aug. 16, 2007

(54) Method and system for restricting automatic out-of-office email response to configured zone

(75) Inventors: John Vuong, San Jose, CA (US); Sarah Korah, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/354,785

(22) Filed: Feb. 14, 2006

(51) Int. Cl. G06F 15/16

(52) U.S. Cl. 709/206

(57) ABSTRACT

A method for restricting an automatic out-of-office email response to a configured zone includes steps as follows. At least one domain name is specified for receiving the automatic out-of-office email response. An email is received from an email account. It is verified whether the email originates from one of the at least one domain name. When the verification is successful, the automatic out-of-office email response is sent to the email account.

### BACKGROUND OF THE INVENTION

The present invention relates generally to email services, and more particularly to a system and method for restricting an automatic out-of-office email response to a configured zone.

A simple electronic mail (hereinafter email) system typically includes an email server operatively connected to a number of email client applications. A more realistic implementation is that the email system includes a number of similar or different email servers connected together via a network. Each of the email servers is also operatively connected to a number of email client applications. In either case, the email server is typically implemented by email server software running on a computer system. The computer system may be a server computer, a workstation computer, a mainframe computer, or a super-computer. The computer system may also be a number of computers connected together via a network. The email server software may be the Microsoft Exchange® email server software manufactured and sold by Microsoft Corporation of Redmond, Wash. Other commercial email servers such as IBM's Lotus Domino, Sun/AOL iPlanet Messaging Server, and the like may also be used.

Each email client application is typically implemented by software running on a user terminal or client device. The user terminal may be a personal computer system, or a non-traditional-computer digital device, such as a personal digital assistant, a pager, a cellular phone, or the like. The email client application may be implemented in a variety of ways. One example of the email client application is the Microsoft Outlook® email client application software manufactured and sold by Microsoft Corporation of Redmond, Wash. Another example of the email client application may be the Netscape Communicator® (or Netscape 8.0) client manufactured and made available by AOL-Time Warner, Inc. of New York, N.Y. The Netscape Communicator® is a comprehensive set of components that integrates browsing, email, and chat functions together to allow users to easily communicate, share, and access information. A further example of the email client application may be the AOL® 9.0 interactive service software (which includes the email function) also manufactured and made available by AOL-Time Warner, Inc. of New York, N.Y. Other examples may include Mozila thunderbird, and web-mail clients such as gmail, hotmail, and the like.

Each user terminal is connected to its corresponding email server computer (i.e., the computer system that runs the email server software) via a communication network. The email servers and the client applications communicate with each other following a client-server model and rely on the Transmission Control Protocol (TCP) for reliable delivery of information or applications between servers and client applications.

Each user of an email client application is assigned with an email address. When a user of a particular email address logs into an email system through an email client application, the email client application assumes the email address of the logged-in user. The email client application then communicates with its corresponding email server to receive all email messages sent to that particular email address. The user may also send email messages to other email addresses via the email client application.

Some of the conventional email client applications may also include additional functions. For example, the Microsoft Outlook® email client application provides an out-of-office Assistant function to its user. The out-of-office Assistant function, when set for an email address, automatically sends a pre-composed reply message to any message sent to that email address. Thus, this function is an auto-reply function that allows a sender of an email message to immediately know that the intended recipient will not read the message in a timely way.

However, the default mechanism of automatically sending the out-of-office reply to all sending email addresses may provide the user's email address to spammers, which may result in unwanted emails in the user's inbox. In fact, out-of-office replies often contain information which may be misused by spammers or by competition. A user often sets up out-of-office response emails with details about the alternate contacts. A typical out-of-office email response is of the format “John Doe will be out of office until Jan. 1, 2006. In case of an emergency please contact my manager Mr. Joe Manager at manager.joe@company.com”. In some cases, the alternate contact's phone number is also mentioned in the out-of-office reply. Information like this may be harmful if it lands in the hands of unscrupulous people or spammers.

In spite of filtering, spam email and viruses often reach corporate mailboxes. Most employees may diligently delete these emails without opening them or replying to them. However, it is a security loophole when an employee is out of office. These potentially dangerous and unsolicited emails may be automatically replied to. The reply confirms the existence of the employee's email address, thereby making it more susceptible to future attacks. Auto replies may also contain an alternate contact's email address or phone number, possibly compromising those contacts.

It is possible to specify that out-of-office replies should only be sent in response to emails from specific contacts in the FROM field. However, it is very difficult to individually specify all the email addresses to which an out-of-office response may be sent. While out-of-office replies typically contain information which is relevant only to people within the corporate network, it may be impossible to specify that out-of-office replies should only be sent to people within the intranet.

An email user, who is concerned about his out-of-office replies unintentionally reaching wrong recipients, may choose not to use the out-of-office option. However, this means that out-of-office replies are not sent to anyone. Alternatively, the email user may manually enumerate a list of contacts to which out-of-office responses may be sent. However, this is a difficult, error prone and time consuming process.

Consequently, it would be desirable to provide a method and system which may effectively address the foregoing-described problems.

### SUMMARY OF THE INVENTION

In an exemplary embodiment of the present invention, a method for restricting an automatic out-of-office email response to a configured zone includes steps as follows. At least one domain name is specified for receiving the automatic out-of-office email response. An email is received from an email account. It is verified whether the email originates from one of the at least one domain name. When the verification is successful, the automatic out-of-office email response is sent to the email account.

In an additional exemplary embodiment of the present invention, an email system includes a sender email server coupled to a sender email client application, and a recipient email server coupled to a recipient email client application. The email system is configured to implement a method for restricting an automatic out-of-office email response to a configured zone, wherein the method includes steps as follows. At least one domain name is specified for receiving the automatic out-of-office email response. The recipient email client application receives an email from the sender email client application. It is verified whether the email originates from one of the at least one domain name. When the verification is successful, the automatic out-of-office email response is sent to the sender email client application.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates an email system including an email server system and a number of client systems with their email client applications in accordance with an exemplary embodiment of the present invention;

FIG. 2 illustrates an email system including a number of email servers that communicate messages among one another and also to a number of client applications in accordance with another exemplary embodiment of the present invention; and

FIG. 3 is a flowchart of a method for restricting an automatic out-of-office email response to a configured zone in accordance with an exemplary embodiment of the present invention.

### DETAILED DESCRIPTION OF SPECIFIC EMBODIMENTS

Reference will now be made in detail to the presently preferred embodiments of the invention, examples of which are illustrated in the accompanying drawings.

The present invention may allow email users to restrict out-of-office automated replies to be sent only to intranet zone and/or trusted zones. Trusted zones (or configured zones) may include email accounts and email addresses from the person such as friends, family members, important clients, and the like, to whom the user desires the automated reply to send. In one aspect, the present invention provides the email user with an option of restricting the automatic sending of out-of-office replies to emails from well-known groups of contacts, such as people within the intranet and/or contacts from the email recipient's address book.

Many email systems allow users to set up out-of-office responses. This is typically implemented by specifying a variety of parameters like the time period during which the email user is out of office, the content of the out-of-office email, the list of users to whom the out-of-office reply must be sent if mail is received FROM them, and the like.

The typical out-of-office configuration allows email users to narrow down the list of recipients to whom the out-of-office email may be sent. This is achieved by specifying a rule or configuration, which indicates that out-of-office email responses will be sent only if the original email is sent from a specified list of individual email aliases. The problem with this approach is that it may be difficult to enlist all the allowed email aliases because there may be hundreds or thousands of allowed email aliases in the corporate address book. Similarly, there may be hundreds of email addresses in the user's personal address book to whom the user is interested in sending out-of-office email responses.

Conventionally, the email user may specify individual email addresses from a corporate address book or personal address book while configuring the FROM field in out-of-office configuration. What most users need is an option to restrict the automatic sending of out-of-office replies to emails to all members in well known groups of contacts such as people within the intranet and/or contacts from the email recipient's address book. The present invention provides a new option named “Zone”, which may allow users to specify the domain names that may receive automatic out-of-office email responses. The email client/server may then verify that the original mail originates from one of the domain names listed in the Zone configuration, and send an automatic email response only if the verification is successful. This may allow for not only the ability to restrict automatic responses to intranet but also to trusted zones.

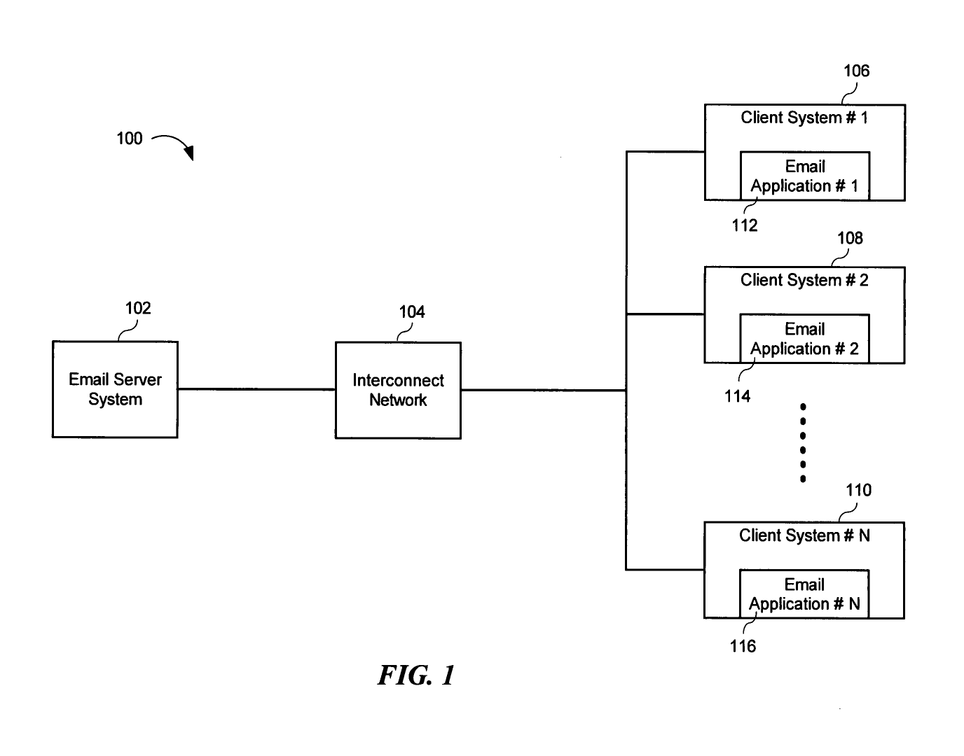

Referring now to FIG. 1, an email system 100 that may implement one embodiment of the present invention is shown. Hereinafter, the term “email” refers to various kinds of electronic mail. For example, the email may be a text email, a voice email, a video email, or the like. The email system 100 includes an email server system 102 and a number of client systems 106, 108, 110 connected to the email server system 102 via an interconnect network 104. Each of the client systems 106, 108, 110 includes an email client application (i.e., 112, 114, 116). The email applications 112, 114, 116 may also be referred to as client applications or simply clients. Each of the client systems 106, 108, 110 may be a personal computer system or a non-traditional-computer digital device such as a personal digital assistant, a pager, a cellular phone, and the like. Each of the client systems 106, 108, 110 also runs one of the email applications 112, 114, 116. Each of the client systems 106, 108, 110 is connected to the email server system 102 via an interconnect network 104. The network 104 may be any kind of known network, such as Ethernet, ISDN (Integrated Services Digital Network), T-1 or T-3 link, FDDI (Fiber Distributed Data Network), cable or wireless LMDS network, or telephone line network.

The server system 102 forwards messages among the applications 112, 114, 116 based on email addresses specified in the messages. The email server system 102 and the email applications 112, 114, 116 communicate with each other following a client-server model and rely on the Transmission Control Protocol (TCP) for reliable delivery of information between the server system 102 and the email applications 112, 114, 116. Each application assumes a unique email address when communicating with the server 102. The email applications 112, 114, 116 are employed mainly to allow their users to send and/or receive email messages via the email server system 102.

The email server system 102 may be implemented, for example, by email server software running on a computer system. The computer system may be a server computer, a workstation computer, a mainframe computer, or a super-computer. The computer system may also be a number of computers connected together via a network. The main functions of the email server system 102 include managing email addresses, receiving email messages, delivering queued email messages to client applications, and forwarding email messages to their appropriate destinations.

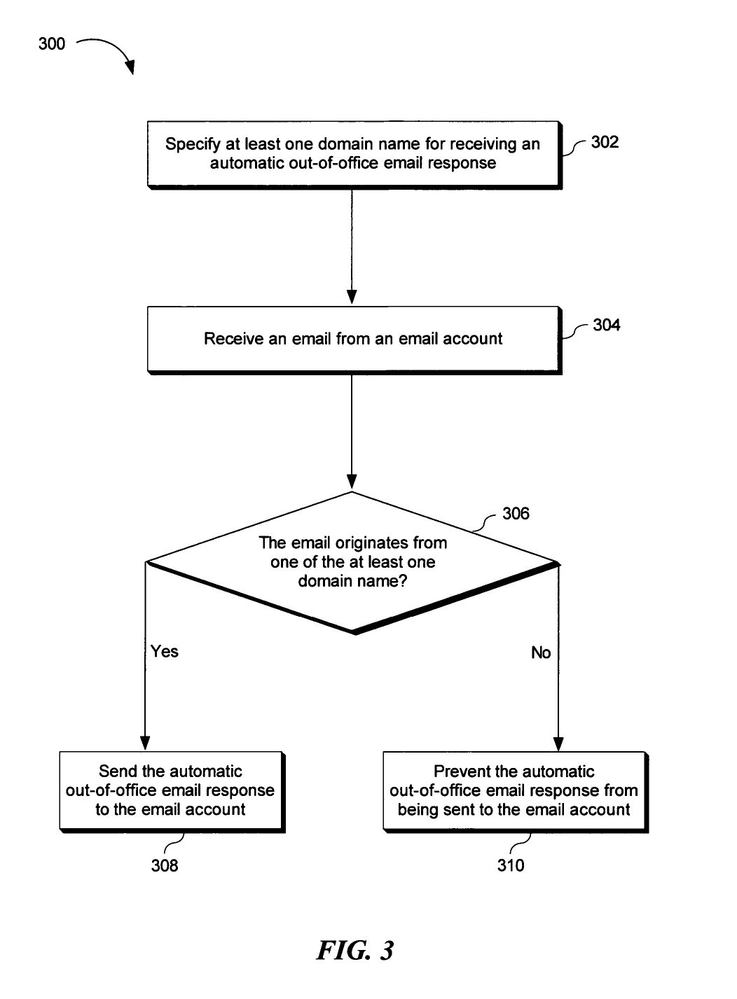

In accordance with one embodiment of the present invention, the email system 100 may allow users of the email applications 112, 114, 116 to restrict an automatic out-of-office email response to a configured zone (i.e., trusted zone), which will be explained in detail when describing FIG. 3.

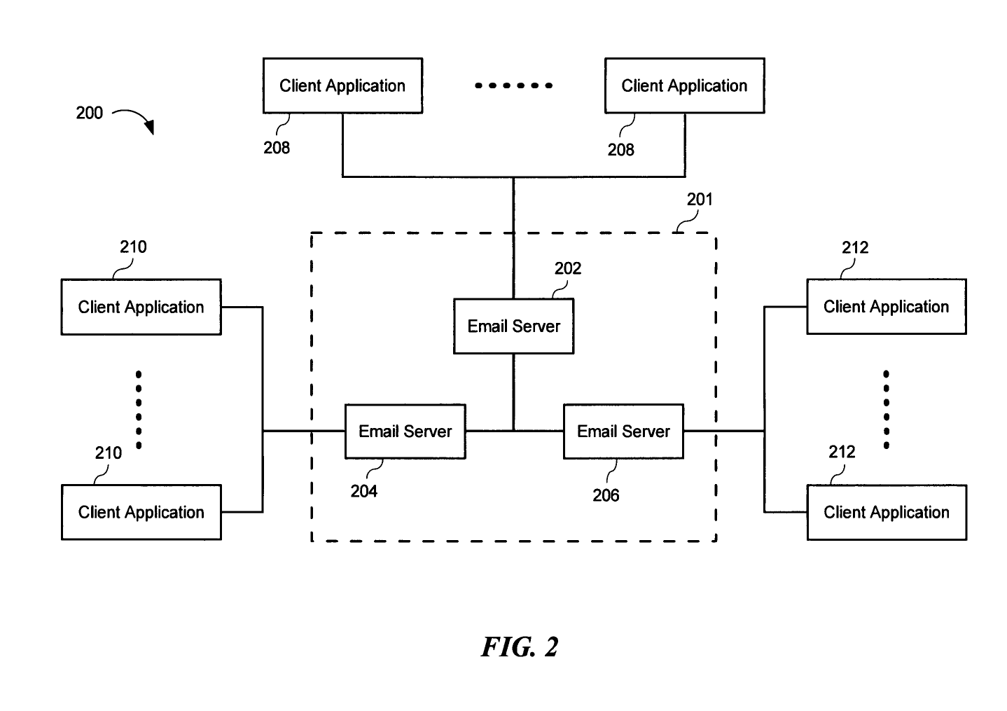

FIG. 2 shows another email system 200 that also implements one embodiment of the present invention. Like the email system 100 of FIG. 1, the email system 200 of FIG. 7 also allows a user of the system to restrict an automatic out-of-office email response to a configured zone. The main difference is that the email system 200 of FIG. 7 includes an email server system 201 that includes multiple email servers (i.e., email servers 202, 204, 206) operationally connected together. Alternatively, they are not connected together, but are connected such that they may exchange messages. As shown in FIG. 7, each of the email servers 202, 204, 206 is also operationally connected to a number of email client applications. For example, the email server 202 is connected to a number of email client applications 208, while the email server 204 is connected to a number of email client applications 210 and the email server 206 is connected to a number of email client applications 212. This means that each of the email servers 202, 204, 206 only manages some of the email addresses of the email system 200.

When one email client application (e.g., the application 210) sends an email message to another email application connected to another email server (e.g., the application 212), the email server 204 forwards the email message to the email server 206, which in turn forwards the message to the appropriate email application, as is common in practice. Under this scenario, the email server 204 is the sender email server and the email server 206 is the recipient email server; the client application 210 is the sender email client application and the client application 212 is the recipient email client application. Alternatively, the sender email server and the recipient email server may be a single server. For example, as shown in FIG. 1, when the email application 112 sends an email to the email application 116 via the email server system 102 and when the email server system 102 includes a single server, the email server system 102 is both the sender email server and the recipient email server.

FIG. 3 shows a method 300 for restricting an automatic out-of-office email response to a configured zone (i.e., a list of trusted domain names). For example, the configured zone may be part of intranet. The method 300 may be implemented in the email system 100 of FIG.1 and the email system 200 of FIG. 2. At least one domain name is specified for receiving an automatic out-of-office email response 302. For example, the at least one domain name may be listed in a configuration of the option “Zone”. An email is received from an email account 304. It is verified (e.g., by the email client or email server) whether the email originates from one of the at least one domain name 306. When the verification is successful, the automatic out-of-office email response is sent to the email account 308. When the verification is not successful, the automatic out-of-office email response is prevented from being sent to the email account 310.

The present invention may be used by all kind of email systems, including Microsoft Outlook® and Hotmail manufactured and sold by Microsoft Corporation, GMail developed by Google, Inc., the email service provided by Yahoo, AOL-Time Warner, Inc., and the like without departing from the scope and spirit of the present invention.

The present invention may have the following advantages. First, it provides an email user with a novel option of restricting an out-of-office reply to a configured zone. Moreover, it helps protect email users from unintentionally replying to spammers and/or sending sensitive information outside intranet such as the corporate network. Additionally, it may reduce the user's effort by eliminating unnecessary tedious and error prone steps while configuring intended recipients for an out-of-office response. Further, it addresses a security loop hole in the existing out-of-office response feature.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not necessarily meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for restricting an automatic out-of-office email response to a configured zone, comprising steps of:
specifying at least one domain name for receiving the automatic out-of-office email response;
receiving an email from an email account;
verifying whether the email originates from one of the at least one domain name; and
sending, when the verification is successful, the automatic out-of-office email response to the email account.

2. The method as claimed in claim 1, further comprises a step of preventing, when the verification is not successful, the automatic out-of-office email response from being sent to the email account.

3. The method as claimed in claim 1, wherein the verifying step is performed by an email client.

4. The method as claimed in claim 1, wherein the verifying step is performed by an email server.

5. The method as claimed in claim 1, wherein the configured zone is part of intranet.

6. The method as claimed in claim 1, wherein the at least one domain name is listed in a configuration of an option.

7. A system for restricting an automatic out-of-office email response to a configured zone, comprising:
means for specifying at least one domain name for receiving the automatic out-of-office email response;
means for receiving an email from an email account;
means for verifying whether the email originates from one of the at least one domain name; and
means for sending, when the verification is successful, the automatic out-of-office email response to the email account.

8. The system as claimed in claim 7, further comprises means for preventing, when the verification is not successful, the automatic out-of-office email response from being sent to the email account.

9. The system as claimed in claim 7, wherein the means for verifying includes an email client.

10. The system as claimed in claim 7, wherein the means for verifying includes an email server.

11. The system as claimed in claim 7, wherein the configured zone is part of intranet.

12. The system as claimed in claim 1, wherein the at least one domain name is listed in a configuration of an option.

13. An email system, comprising:
a sender email server coupled to a sender email client application; and
a recipient email server coupled to a recipient email client application,
wherein the email system is configured to implement a method for restricting an automatic out-of-office email response to a configured zone, the method comprising steps of:
specifying at least one domain name for receiving the automatic out-of-office email response;
receiving, by the recipient email client application, an email from the sender email client application;
verifying whether the email originates from one of the at least one domain name; and
sending, when the verification is successful, the automatic out-of-office email response to the sender email client application.

14. The email system as claimed in claim 13, wherein the method further comprises a step of preventing, when the verification is not successful, the automatic out-of-office email response from being sent to the sender email client application.

15. The email system as claimed in claim 13, wherein the verifying step is performed by the recipient email client application.

16. The email system as claimed in claim 13, wherein the verifying step is performed by the recipient email server.

17. The email system as claimed in claim 13, wherein the at least one domain name is listed in a configuration of an option of the recipient email client application.

18. The email system as claimed in claim 13, wherein the sender email server and the recipient email server are part of intranet.

19. The email system as claimed in claim 13, wherein the sender email server and the recipient email server are a single server.
